(19) United States
(12) Patent Application Publication
(10) Pub. No.: US 2005/0108137 A1
(43) Pub. Date: May 19, 2005

(54) Diversification management system and method

(76) Inventors: Jeffrey D. Winkler, Oakland, CA (US); James M. Drury, Danville, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 10/718,104

(22) Filed: Nov. 19, 2003

(51) Int. Cl. G06F 17/60

(52) U.S. Cl. 705/36

(57) ABSTRACT

A user selects (a) a classification system involving different asset classes, (b) the asset classes in which investments are to be made in the classification system and (c) a limit to the investments in each asset class. The user also selects the mode (e.g., mail, e-mail, facsimile) in which the user is to be periodically notified of the user's investments, and the investment value in each asset class. The user is notified when the assets in a class exceed the established limit. The user may (a) do nothing, (b) change the limit in the asset class or (c) change the asset classes. The user may change the notification mode, and the notification periodicity, when the investment in an asset class increases above the established limit or when the excess above the limit continues to exist. The user may be a user, an agent for a user or an agent for a group of users.

This invention relates to a system for, and method of, controlling investments for an investor or user in accordance with selections made by the investor or user of the asset classes, and the limits in each asset class, in which investments are to be made for the investor or user.

### BACKGROUND OF THE INVENTION

The number of people investing in securities has increased dramatically in recent years The amount of money available for investment by each average investor has also increased dramatically in recent years. As a result, the total amount of money available by all of the investors or users has increased dramatically in recent years.

Most individuals do not make their own decisions to invest. There are a number of reasons for this. Among them are a lack of time, a lack of interest, a lack of confidence, and/or a lack of knowledge. Because of this, most individuals rely on third parties to make investments for them. Many of these third parties are experts with considerable years of experience. Most experts recommend that clients provide a diversification of investments because this is a safer way to proceed.

Investors today typically try to manually manage asset class reporting across potentially hundreds or thousands of different combinations of investments within multiple accounts, and then attempt to manually make the changes to investments at the detail level within accounts to ensure asset class accuracy. In some cases investors use multiple non-integrated systems to manage pieces of the asset management process, but then rely on many manual steps to complete the process. For example, the analysis may be partially automated but the trading and tax reporting is manual, making the project essentially impossible to carry out.

For a typical portfolio of diverse stocks, bonds, mutual funds, options, warrants, and private equity, across a typical number of 8-10 accounts with different tax treatments, the time required in a day or week to complete the analysis, adjust the trades, and recalculate results using today's non-integrated systems greatly exceeds the time available to complete the steps given the time constraints of trading hours and market volatility. Therefore, once the analysis is complete in a time period, market changes typically have made the analysis incorrect and often counter productive. By contrast, the system disclosed and claimed in this application is a fully automated system combining the previously separate functions of definition, analysis, notification, execution, tax calculation, and verification across either one account or multiple accounts in an environment that can be completed and executed upon on a continual basis. The previous constraints of lengthy analysis and execution time are therefore no longer a constraint because of the closed loop automation.

It would be desirable for a balanced relationship to be provided between investors and the agents providing investment decisions for these investors. For example, it would be desirable for investors to choose an individual one of the classification systems among the plurality that are available. Among these services are those offered by Morningstar, Lipper, Ibbotson and others, including user defined services. Each classification service separates equities into different asset classes. The asset classes provided for one classification system may not be the same as the asset classes provided for another classification system. It would accordingly be desirable for an investor to choose asset classes in the asset classification system that the investor has selected. It would also be desirable for investments made on behalf of the investor to have upper limits of dollar value so that the investments in the different asset classes will not become unbalanced as a result of appreciating assets in some asset classes and depreciating assets in other asset classes.

### BRIEF DESCRIPTION OF A PREFERRED EMBODIMENT OF THE INVENTION

A user selects (a) a classification system involving different asset classes, (b) the asset classes in which investments are to be made in the classification system and (c) a limit to the investments in each asset class. The user also selects the mode (e.g., mail, e-mail, facsimile) in which the user is to be periodically notified of the user's investments, and the investment value, in each asset class. The user is notified when the assets in a class exceed the established limit. The user may (a) do nothing, (b) change the limit in the asset class or (c) change the asset classes. The user may change the notification mode, and the notification periodicity, when the investment in an asset class increases above the established limit or when the excess above the limit continues to exist. The user may be a user, an agent for a user or an agent for a group of users.

### BRIEF DESCRIPTION OF THE DRAWINGS

In the drawings:

FIG. 1 is a circuit diagram, primarily in block form, of a system for managing investments for a user;

FIG. 2 is a flow chart showing in block form actions of the user in selecting (1) asset classes in an individual one of a plurality of asset classification systems, (2) limits of the investments in the asset classes selected and (3) modes of notifying the user when the investments in a selected one of the asset classes are outside of the limits established for the selected asset class;

FIG. 3 is a flow chart showing in block form actions of the user when the investments of the user are outside of limits established by the user for different asset classes;

FIG. 4 is a flow chart showing in block form the steps in determining if the assets in each selected class in the asset classification system is outside of investment limits for the asset class;

FIG. 5 is a flow chart showing in block form the method of notifying the user that the investment in an individual one of the asset classes is the outside of limits established for the asset class;

FIG. 6 is a flow chart showing in block form the different actions available to the user when the investments of the user in a selected one of the asset classes is outside of a particular limit for the asset class and showing the selection by the user of an individual one of the actions available to the user;

FIG. 7 is a flow chart showing in block form the actions available to be taken by a user in notifying a client when the investment of the client is outside of the limit established by the client for an asset class;

FIG. 8 is a flow chart showing in block form the actions taken by a user when the user is a participant and when the investment of the user in an asset class selected by the user has a limit established by the user for the asset class.

### DETAILED DESCRIPTION OF A PREFERRED EMBODIMENT OF THE INVENTION

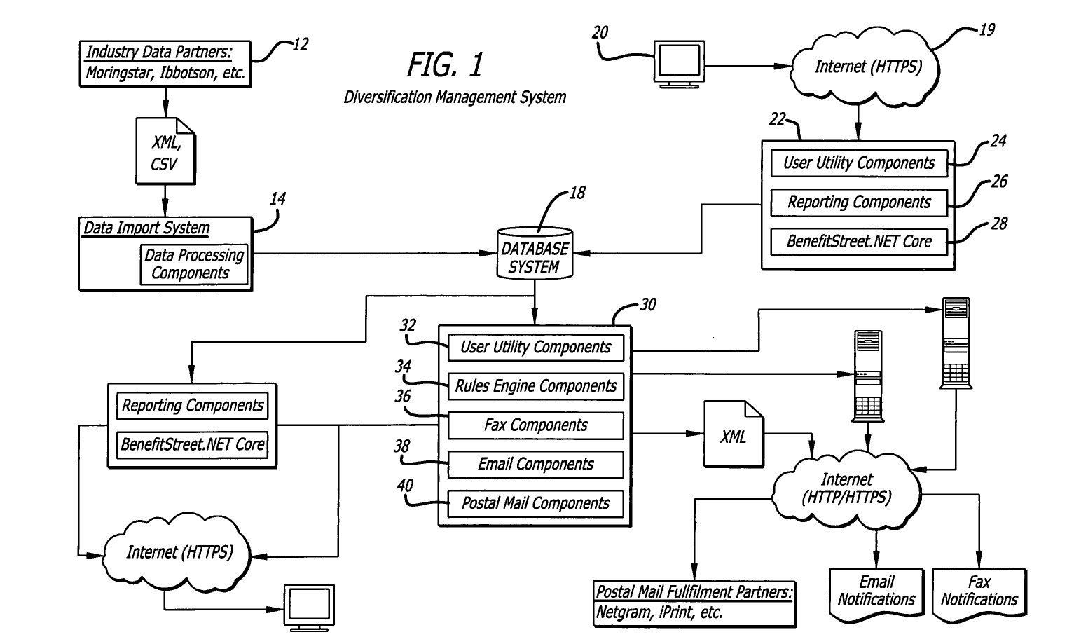

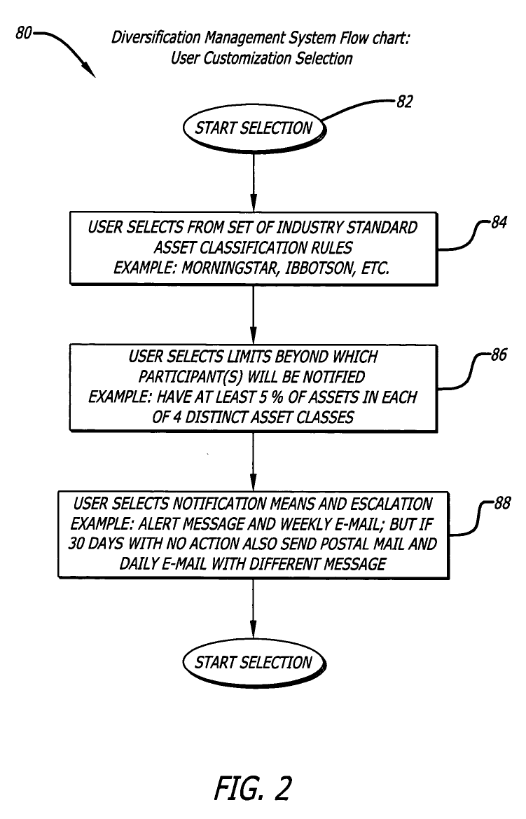

FIG. 1 is a circuit diagram, primarily in block form, of a system, generally indicated at 10, constituting a preferred embodiment of the invention. FIGS. 2-8 constitute flow charts, primarily in block form, showing the operation of the system 10. The system 10 in FIG. 1 provides indications to a user of investments made by or for a user in different asset classes and indications of whether investments by the user in different asset classes exceed limits established by the user for the asset classes.

The user may be an individual or participant making his or her own investments. The user may also be an advisor, administrator, mutual fund representative or plan sponsor, either as an individual or a group, for managing the investments of an individual participant or user or for managing the combined investments or investment plans of a plurality of individuals or participants or for managing the assets of a corporation, general partnership, limited partnership or any other form of legal entity.

The system 10 can operate with any one of a plurality of asset classification systems. Examples of suitable asset classification systems are Morningstar, Ibbotson, Lipper, and others, including user defined services. Each of these asset classification systems designates a plurality of asset classes. Examples of different classes on a broad classification basis include stocks (common and preferred), corporate and government bonds (which can be further classified into federal, state and local), mutual funds, mortgages and index funds. Each asset classification system may designate different asset classes than the others. The selection of the asset classification system is indicated at 12 in FIG. 1 and is indicated as Industry Data Partners.

Examples of typical asset classes are as follows:
Large Cap Publicly Traded US Equity—Growth
Large Cap Publicly Traded US Equity—Value
Mid Cap Publicly Traded US Equity—Growth
Mid Cap Publicly Traded US Equity—Value
Small Cap Publicly Traded US Equity—Growth
Small Cap Publicly Traded US Equity—Value
Micro Cap Publicly Traded US Equity—Growth
Micro Cap Publicly Traded US Equity—Value
Large Cap Publicly Traded International Equity—Growth
Large Cap Publicly Traded International Equity—Value
Mid Cap Publicly Traded International Equity—Growth
Mid Cap Publicly Traded International Equity—Value
Small Cap Publicly Traded International Equity—Growth
Small Cap Publicly Traded International Equity—Value
Micro Cap Publicly Traded International Equity—Growth
Micro Cap Publicly Traded International Equity—Value
Large Cap Publicly Traded US Taxable Debt, Non-Convertible
Large Cap Publicly Traded US Taxable Debt, Convertible
Small Cap Publicly Traded US Taxable Debt, Non-Convertible
Small Cap Publicly Traded US Taxable Debt, Convertible
Large Cap Publicly Traded US Taxable Debt
Small Cap Publicly Traded US Taxable Debt
Large Cap Publicly Traded US Municipal Debt
Small Cap Publicly Traded US Municipal Debt
Large Cap Non-Publicly Traded US Equity—Growth
Large Cap Non-Publicly Traded US Equity—Value
Mid Cap Non-Publicly Traded US Equity—Growth
Mid Cap Non-Publicly Traded US Equity—Value
Small Cap Non-Publicly Traded US Equity—Growth
Small Cap Non-Publicly Traded US Equity—Value
Micro Cap Non-Publicly Traded US Equity—Growth
Micro Cap Non-Publicly Traded US Equity—Value
Large Cap Non-Publicly Traded International Equity—Growth
Large Cap Non-Publicly Traded International Equity—Value
Mid Cap Non-Publicly Traded International Equity—Growth
Mid Cap Non-Publicly Traded International Equity—Value
Small Cap Non-Publicly Traded International Equity—Growth
Small Cap Non-Publicly Traded International Equity—Value
Micro Cap Non-Publicly Traded International Equity—Growth
Micro Cap Non-Publicly Traded International Equity—Value
Large Cap Non-Publicly Traded US Taxable Debt, Non-Convertible
Large Cap Non-Publicly Traded US Taxable Debt, Convertible
Small Cap Non-Publicly Traded US Taxable Debt, Non-Convertible
Small Cap Non-Publicly Traded US Taxable Debt, Convertible
Large Cap Non-Publicly Traded US Taxable Debt
Small Cap Non-Publicly Traded US Taxable Debt
Large Cap Non-Publicly Traded Options and Warrants
Mid Cap Non-Publicly Traded Options and Warrants
Small Cap Non-Publicly Traded Options and Warrants
Micro Cap Non-Publicly Traded Options and Warrants
Money Market Funds, Taxable
Money Market Funds, Municipal

After selecting the asset classification system as indicated at 12 in FIG. 1, the user can select the asset classes in which investments are made. For example, the user can select a portfolio of bonds and mutual funds or the user can select a more aggressive portfolio of common stocks. The user can even distinguish between different types of stocks such as growth stocks and income stocks. This is indicated at 14 in FIG. 1. The selection of the asset classes in the selected asset classification system is indicated at 14 in FIG. 1.

The user can indicate the amount of money to be invested by the user in each asset class selected by the user. If the user so desires, the user can indicate the dollar limit for the investment in each asset class or at least in selected ones of the asset classes. When the investment limit for an asset class is exceeded, the user can designate what should be done with the excess above the investment limit for the asset class. For example, the user can establish an increased investment limit for the asset class. Alternatively, the user can select another asset class different from the asset classes previously established by the user and can have the excess disposed in this new asset class to establish the new asset class. The selection of investment limits for different asset classes may be considered to be included in the block 14. The selection may be made in real time at pre-selection intervals.

The user can select the mode by which the user is to be notified how the user's investment are faring. For example, the notification can be email, regular mail or facsimile. The user can also designate the times when the user is to be notified about the user's investment. For example, this notification can be once a week. The day of the week for each notification can even be designated. The user can designate separately what the mode of notification should be when the investment in an asset class exceeds the investment limit for the asset class. This mode of notification may be different from the mode of notification when the user is notified how his investments are faring. For example, such notification may be by regular mail but notification of investment above an established limit in an asset class may be by registered mail. The selection of the mode for notification may be considered to be included in the block 14.

The data import system 14 establishes rules relating to asset classes, investment limits for the asset classes and modes of notification relating to investment values in asset classes. These rules are introduced to a database 18 which may illustratively be an Oracle database. The database 18 processes data which is introduced to the database in accordance with the rules established by the Data Import System 14.

A custom web interface for a participant is indicated at 20. The custom web interface 20 allows an individual user, a participant, to personalize or customize selections such as asset classes, investment limits in the asset classes, modes of notification to the user concerning investment values in the different classes and amounts, if any, in excess of the limits established for the asset classes and specialized notifications to the user in case of continued investment values above the minimum for these asset classes. The custom web interface 20 allows a participant to personalize or customize industry standard selection, mode of notification and diversification rules among different asset classes. This information is introduced from the custom web interface 18 through the internet 19 to a user customization system 22.

The user customization system 22 includes section 24 entitled User Utility Components, a section 26 entitled Reporting Components and a section 28 entitled BenefitStreet Core. (BenefitStreet, Inc. is the assignee of record of this patent application.) The BenefitStreet Core 28 provides the software for operating the user customization system 22. The user utility components 24 provide the rules established by the user to control the user's investments. These include asset classes, investment limits for asset classes and notifications of these investment limits on an escalated basis. The data generated for determining the investment limits in the different asset classes and any excesses above the investment limits in the different asset classes are provided in the section 26. The information from the user customization system 22 is introduced to the database 18. The data base then processes the data in accordance with the established rules.

The data provided by the database 18 is introduced to a notification system 30. The notification system 30 continuously polls the database 18 to obtain information from the database concerning the participant's investment information or concerning the user's investment information when the user manages more than one (1) investment account. The notification system 30 applies personalized diversification or customization rules concerning a user's investment and provides appropriate notifications in accordance with specifications established by a participant or specifications established by the user as an administrator and giving the user, as an administrator, the right to override the specifications established by a participant.

The notification system 30 includes a section 32 entitled User Utility Components, a section 34 entitled Rules Engine Components, a section 36 entitled Tax Components, a section 38 entitled Email Components and a section 40 entitled Postal Mail Components. The section 26 entitled Tax Components calculates and retains the tax gain or loss for the investor. This allows asset class changes to be merged within tax advantaged accounts per the parameters of the Rules Engine Components.

The section 32 entitled User Utility Components corresponds to the section 24 also entitled User Utility Components. The User Utility Components 32 provide the rules established by the user to control the investments owned or managed by the user. The Rules Engine Components 34 provide the data to be processed in accordance with these rules. For example, the User Utility Components 32 establish the rule that the user's assets for a selected asset class should not exceed a particular limit. The Rules Engine Components 34 determine if the user's assets in the selected asset class exceeds the established value.

The fax component 36 is operative when the user has provided instructions that the user is to be notified by facsimile that the investment limit in an asset class exceeds the limit established by the user for the asset class. This notification is introduced to a fax server 44 which passes the notification through the internet 19 to facsimile apparatus 46 for notifying the user.

In like manner, an email server 48 receives a notification from the email components 38 when the user has provided instructions that the user is to be notified by email that the investment limit in an account class exceeds the limit established by the user for the asset class. The server 48 passes the notification through the internet 19 to equipment 50 for providing the notification to the user.

The notification by postal mail passes from the postal mail component 40 to postal mail files 52 when the user has provided instructions that the user is to be notified by postal mail that the investment limit established by the user for the asset class. The notification then passes from the postal mail files 52 through the internet 19 to organizations (e.g. NetGram or iPrint) which convert the notification to postal mail.

The data from the database 18 also passes to a reporting system 56. The reporting system 56 provides for access of the system, and notification results, to current participants and groups of participants. The reporting system 56 includes a section 58 designated as Reporting Components and a section 60 designated as BenefitStreet Core. The sections 58 and 60 respectively correspond to the sections 26 and 28 in the User Customization. The section 58 generates data for determining the investment values in the different asset classes and any excesses above investment limits in the different asset classes. The BenefitStreet Core 60 provides software for operating the asset customization system 20 which includes the system for reporting components.

The data from the notification system 30 is also introduced through the internet 19 to a custom web interface 62. The custom web interface 62 allows users, as administrators for more than one participant, to personalize or customize selections such as asset classes, investment limits in the asset classes, amounts, if any, in excess of the limits for the asset classes and modes of notification to users concerning investment values in the different asset classes amounts, if any, in excess of the limits established for the asset classes. The custom web interface 62 is different from the custom web interface 20 in that the custom web interface 20 is for individual participants.

FIG. 2 is a flow chart, generally indicated at 80, indicating various criteria selected or established by a user. A start step is indicated at 82. The user then selects an asset classification from a number of choices including Morningstar and Ibbotson. The user then selects asset classes in the asset classification system. This may be considered to be included within the block 82. For example, the user may select municipal bonds, utilities and index funds as asset classes if the user is a conservative investor. Alternatively, the user may select stocks of small growth companies if the user has a more aggressive approach to investing.

The user then selects limits for selected asset classes. These limits can constitute maximums but they may also include minimums. In other words, the investment in an asset class should be at least a minimum and should not exceed a maximum. The establishment of the limits is indicated at 86 in FIG. 2. The limits do not have to be on a class-by-class basis. For example, a rule can be established that there should be at least four (4) asset classes each having at least five percent (5%) of the investment assets of the user in the asset class. The user can then determine the four (4) asset classes which will have at least five percent (5%) of the total investment assets of the user. The investment limits can be established for an asset class so that the user will be notified when the investment value for the asset class exceeds the limit.

The user can also select the mode in which the user is advised that the investment value in an asset class exceeds the limit established for the asset class. Different modes can illustratively be by regular mail, registered mail, facsimile and e-mail. However, the mode of transmission can also be other forms of communication. The user can additionally select the periodicity of the notification when the investment value in an asset class exceeds the limit established for the class.

The user can further select changes in the periodicity and mode of notification as time progresses after the initial notification to the user of the excess above the limit for the asset class and or as the amount of excess above the limit for the asset class progressively increases. For example, the user may provide for weekly e-mail when the investment value for the asset class is below the maximum limit. However, if the investment value of the investment in the asset class increases above the limit for the asset class, notification may be increased by e-mail to twice a week. If the investment value in the asset class continues to rise above the limit for a period of thirty (30) days and the user has not made a decision during this time as to what to do with the investment value in the asset class above the minimum, the user may decide that the user should be notified daily by regular mail and e-mail and that the mode of notification should be changed to alert the user. This is indicated at 88 in FIG. 2. The end 90 of the flow chart is then provided.

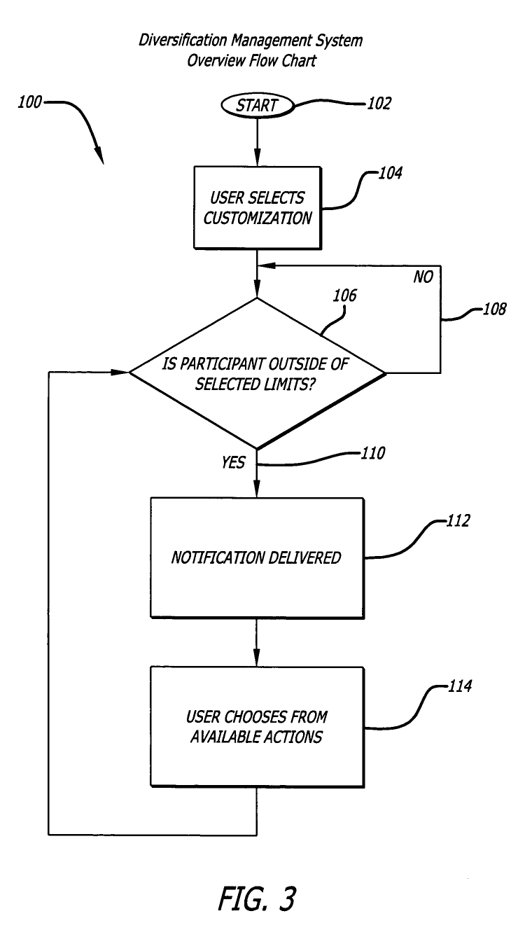

FIG. 3 is an overview flow chart, generally indicated at 100, showing what happens when the value of an investment in an asset class exceeds the limit established by the user for the asset class. The process in the flow chart starts at 102. As a first step 104 the user selects customization. This customization may include the establishment of an individual limit for the asset value in each asset class. A determination is then made as at 106 as to whether the investment value in each asset class is above the limit established by the user for that asset class. When the value of an investment in an asset class is not above the limit established for the user for the asset class, an indication is provided as at 108 and is introduced to the block 106 to determine again whether the investment value in the asset class is above the established limit.

When the investment value of the user in the asset class is above the established limit, an indication is provided as at 110, and a notification is provided to the user as at 112, that the investment value of the asset class is above the established limit. As indicated at 114, the user then chooses from several available alternatives. One alternative is that the user ignores the notification. In this case, the established limit for the asset class continues until the user receives another notification that the investment value in the asset class is above the established limit. Another alternative is that the user changes the established limit of the investment in the asset class. Generally, this change involves an increased limit in the asset class but it can involve a reduced limit.

Another alternative is for the user to establish another asset class with the excess of the investment value above the established limit. An additional alternative is for the user to change the method of notification and/or to change the frequency of the notification. For example, as the value in an asset class continues to increase above an established limit, the frequency of the notification can be increased and the method of notification can be changed from regular mail to e-mail. It will be appreciated that more than one alternative can be simultaneously chosen. For example, the investment limit for an asset class can be changed at the same time that a new asset class is established from the excess of the investment value in the asset class above the established limit or the new limit.

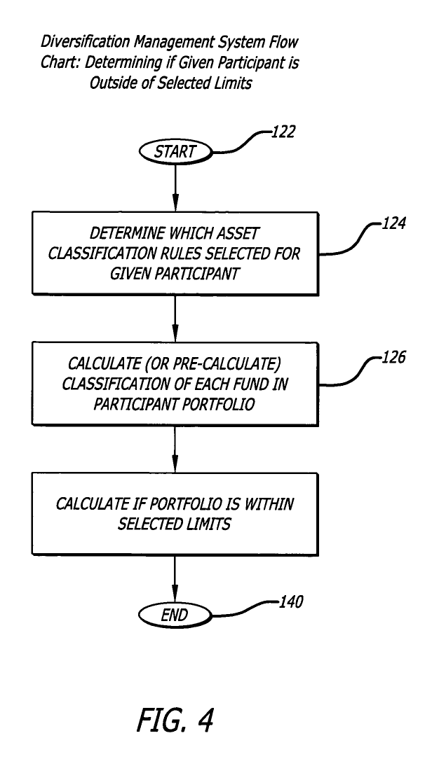

FIG. 4 is a flow chart, generally indicated at 120, indicating if the investment value of a selected asset class of an individual participant is outside of a selected limit. The program is initiated at start (122). The program then moves to a block 124. In this block, a determination is initially made of the asset classification rules (e.g. Morningstar, Ibbotson) selected by the user. The program then provides (126) for a determination of the asset classes in the user's fund (if the user is a participant). The funds of the participant may be considered as a portfolio even though only one individual has assets in the fund. A calculation is then made to determine if the assets in each of the asset classes in the participant's portfolio have a selected limit. This is indicated at 128 in FIG. 4. The end 130 of the flow chart 120 follows.

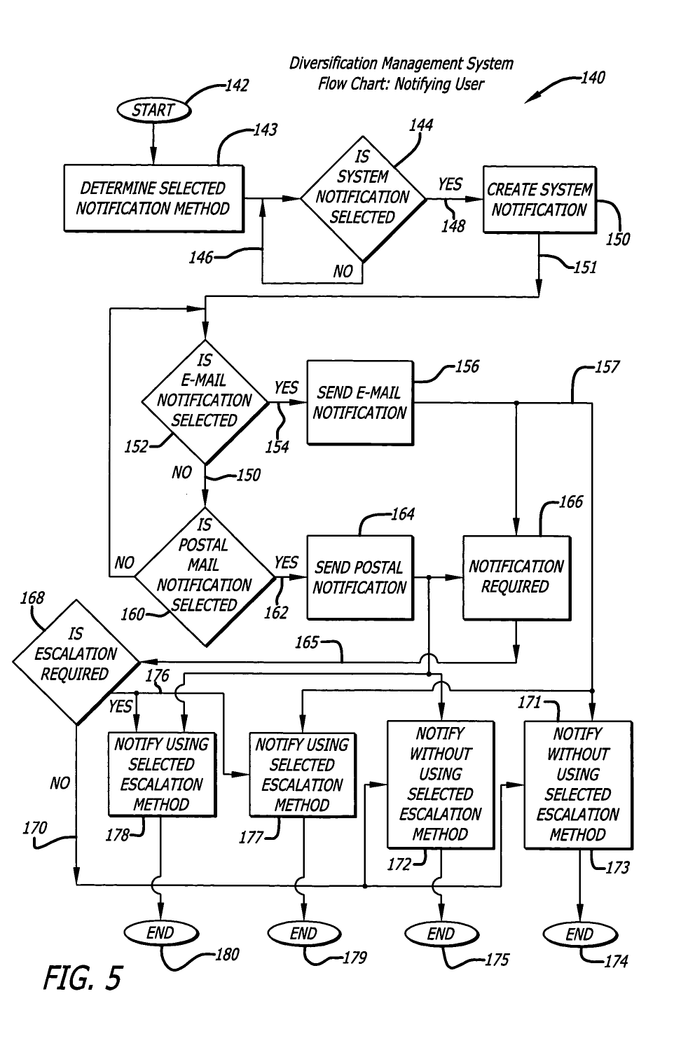

FIG. 5 is a flow chart, generally indicated at 140, showing the operation of the system in notifying a user when the assets in an asset class of the user exceed the limit established for the asset class. The program in the flow chart 140 is started at 142. As a first step 143, a notification mode is selected. A determination is then made (144) as to whether a notification mode has been selected by the user (see 88 in FIG. 2).

If the system notification has not been pre-selected, this is indicated in a line 146 which is returned to the input of the block 144. If the system notification has been pre-selected, an indication of this is provided at 148. This indication is provided to a block 150 which provides for a creation of a system notification. This notification is introduced through a line 151 to a block 152 which indicates whether or not an e-mail notification has been pre-selected by the user.

If the answer is yes (see 154), an instruction 156 to prepare an e-mail notification is provided on a line 157. If an e-mail notification has not been pre-selected by the user (see 158), a block 160 indicates whether or not a postal mail notification has been pre-selected by the user. If the answer is yes (see 162), a provision is made at 164 on a line 165 to prepare a postal notification. Although only notification by e-mail and postal mail have been referenced in FIG. 5, it is believed that a person of ordinary skill in the art will be able to expand FIG. 5 to include other forms of notification such as facsimile and registered mail.

The indications on the lines 157 and 165 respectively from the blocks 156 and 164 are respectively introduced to a block 166 which provides for a notification to the user that the asset value in an asset class selected by the user exceeds a specified limit. An output from the block 166 passes to a block 168 which determines whether an escalation of the notification is required. This escalation may also provide subtle but strong attempts, greater than the normal notification, to obtain a decision by the user as to what to do with the excess of the asset value in the asset class above the pre-selected limit.

The indications on the lines 157 and 165 are also respectively introduced to blocks 171 and 172 which provide for notification of the user without providing an escalation in the mode of notification to the user. The blocks 171 and 172 also receive a notification to the user from the block 168 on a line 170 that no escalation is required. The block 171 accordingly provides a notification by email, without any escalation, to the user of an investment value in an asset class above the investment limit for the asset class when an indication is provided on the line 157. An end 174 occurs when this notification is provided. Similarly, the block 172 provides a notification by postal mail to the user, without any escalation of an investment value in an asset class above the investment limit for the asset class when an indication is provided on the line 165. An end 175 occurs when this notification is provided.

A line 176 from the block 168 indicates that an escalation is required in the notification to the user. The indication on the line 176 is introduced to blocks 177 and 178. The block 177 also receives an indication on the line 157 that a notification to the user is to be provided by email of an investment in an asset class above the limit established for the class. An end 179 is provided when this notification occurs. Similarly, the block 178 receives an indication on the line 165 that a notification to the user is to be provided by postal mail of an investment in an asset class above the limit established for the asset class. An end 180 is provided when this notification occurs.

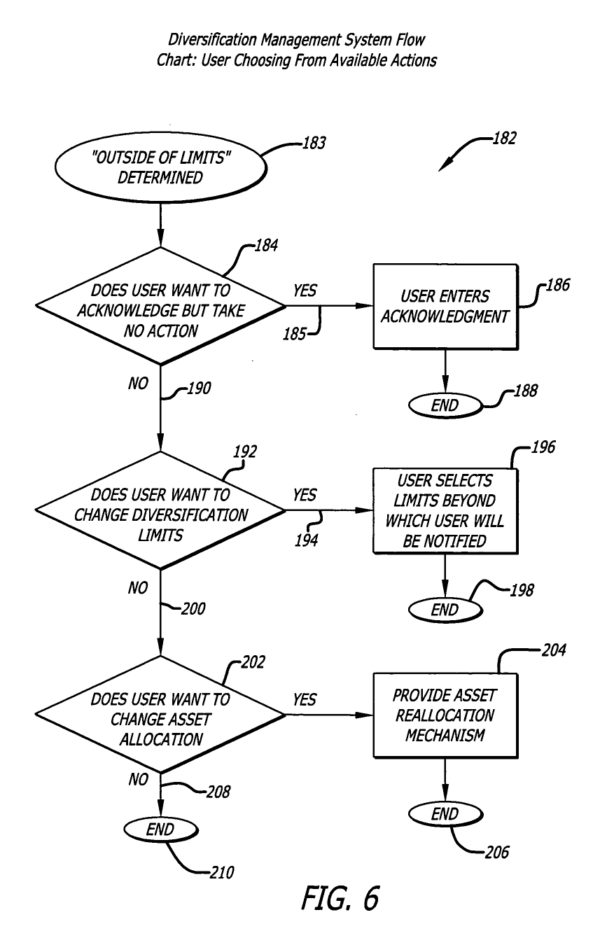

FIG. 6 is a flow chart, generally indicated at 182, providing the user an opportunity to select different alternatives when the asset value of an asset class increases above a limit established by a user whether the user is a participant or a manager of portfolios. As a first step 183, a determination is made that the investment value of an asset class is above the limit for the asset class. The user is then given the opportunity of affirmatively acknowledging the excess of the investment value in the asset class above the limit without taking any action on this excess (see 184). If the user decides to adopt this course of action, this is indicated at 185. The user then enters the acknowledgement. This is indicated at 186. There is then an end 188.

If the user decides that the user does not wish to acknowledge affirmatively without taking action, this is indicated at 190. The user then has to decide whether the user wants to change the investment limit previously established for the asset class in the asset classification system. This is indicated at 192 in FIG. 6. If the answer is yes (see 194), the user selects new investment limits 196 for the asset class. These are the limits beyond which limits the user will be notified. This is then the end 198 of the process in FIG. 6.

If the user does not want to change the acknowledgement limits (see 200), the user is provided with an opportunity as at 202 to determine whether the user wishes to change the asset allocation. One way of doing this is for the user to provide in a different asset class the excess of the investment value above the previous limit established by the user for the asset class. In other words, if the previous limit for asset class A has been $25,000 and the value of the investment in the asset class is now $30,000, the user may retain the limit for asset class A at $25,000 but may establish another asset class B with an initial investment value of $5000. The user then provides an asset reallocation mechanism 204 to accomplish this. This is the then the end 206 of the process. If the user does not want to change the asset allocation, this is indicated at 208. The end 210 of the program then occurs.

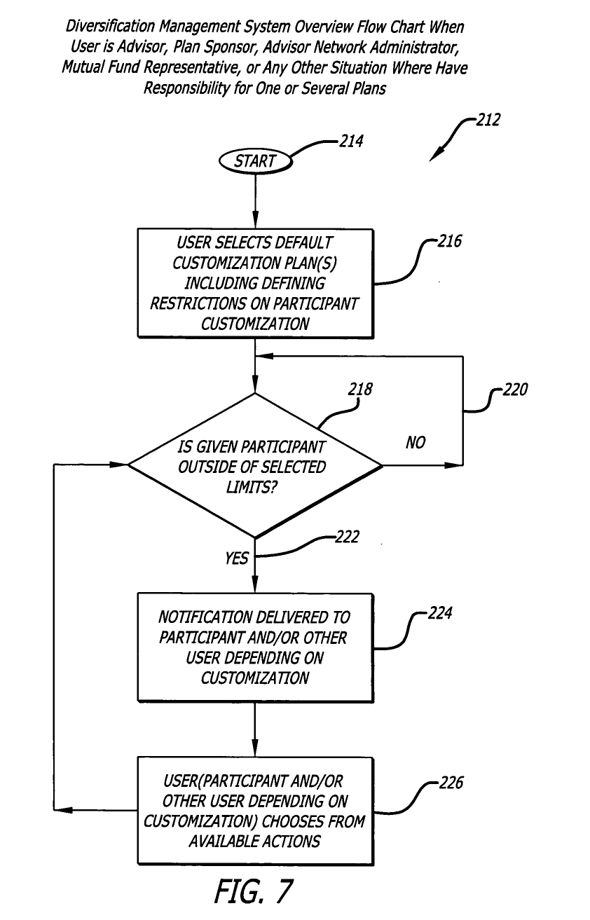

FIG. 7 is a flow chart, generally indicated at 212, providing the user an opportunity to select different alternatives when the asset value of an asset class increases above a limit established by a user and when the user is an advisor, plan sponsor, advisor network administrator, mutual fund representative or person who has a responsibility for one or several plans. A start is indicated at 214. The user then selects the customification parameters for the plan(s) including the asset classes to be provided in the plan(s) and the limits to be established for each asset class. This is indicated at 216.

The user then determines as at 218 if a particular one of the users has an investment in a selected one of the asset classes outside of the limits established for the asset class. If the answer is no, an indication is provided as at 220 to this effect and this indication is introduced back to the block 218 to obtain another determination. If the answer is yes (see 222), a notification to this effect is provided to the participant and/or other users of the excess of the investment value above the limit for the asset class. This is indicated at 224.

The user and/or user(s) then has the opportunity of selecting the individual one of the different alternatives provided to the user and/or the user. Block 226 indicates this. Some of the different alternatives are indicated at 192, 196, 202 and 204 in FIG. 6. The flow chart is then returned to the block 218 to give the user(s) and/or the participant an opportunity to make other selections when the investment value of an asset class increases the limits established by the user and/or user for the asset class.

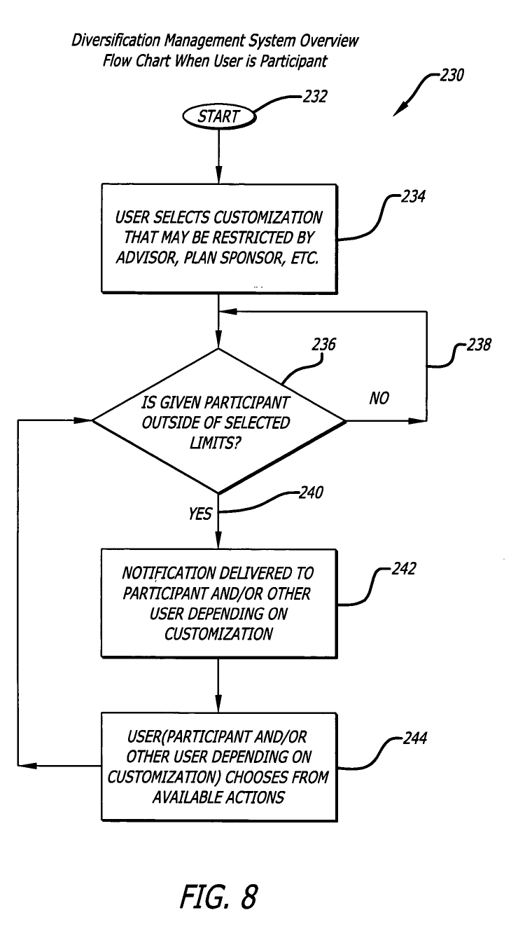

FIG. 8 is a flow chart, generally indicated at 230, indicating a diversification management system overview when the user is a participant. A start of the flow chart is indicated at 232. As a first step indicated at 234, the user selects the customization parameters, including the asset classes and the limits for the asset classes, in the user's investment. These parameters may be restricted by the user after consultation with the user's advisor, plan sponsor, advisor network administrator, mutual fund representative or any individual having responsibility for the user's investment plans and investments.

The user then determines (see 236) if the investment value of any asset class is above the limit established by the user for the asset class. If the answer (238) is no, the position in the flow chart 230 is returned to the input to the block 236. If the answer is yes (see 240), a notification (242) to this effect is delivered to the participant and/or other users in accordance with the customization parameters established by the participant and/or other user(s). The participant and/or other users then select from the various parameters established by the user. This selection is indicated at 244. The selection may be made from among the blocks 192, 196, 202 and 204 in FIG. 6. When the selection has been made, the participant and/or other users are returned to the block 236 for further consideration.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the appended claims.

1. A method of controlling the allocation of investment funds of a user, including the steps of:
selecting from a set of industry standard rules for distinguishing investment asset classes;
selecting, from the selected set of industry standard rules, different asset classes in which the user is to have investments;
selecting the investment limits in which the user is to have investments in the different asset classes selected by the user; and
determining when the user is to be notified that the user's investment in an individual one of the different asset classes is outside of the investment limits established by the user for the individual ones of the different asset classes.

2. A method as set forth in claim 1, including the step of:
selecting the mode by which the user is to be notified that the user's investment in individual ones of the different asset classes is outside of the limits established by the user for these asset classes.

3. A method as set forth in claim 1 wherein
after the user receives notification that the user's investment in individual ones of the different asset classes is outside of the limits established by the user for these asset classes, the user determines what changes, if any, the user wishes to make in the rules by which the user's investment funds are allocated.

4. A method as set forth in claim 1 wherein
the determination is made in real time at pre-selected intervals and wherein
the user is notified in real time of the determination when the determination is made.

5. A method as set forth in claim 1 wherein
the user selects the mode by which the user is to be notified that the user's investment in individual ones of the different asset classes is outside of the limits established by the user for these asset classes and wherein
after the user receives notification that the user's investment in individual ones of the different asset classes is outside of the limits established by the user for these asset classes, the user determines what changes, if any, the user wishes to make in the rules by which his investment funds are allocated and wherein
the determination is made in real time at pre-selected intervals and wherein
the user is notified in real time of the determination when the determination is made.

6. A method of controlling the allocation of investment funds for a user acting on behalf of a participant, including the steps of:
selecting, from a set of industry standard rules, investment asset classes to govern the investment of the user for the participant,
selecting the investment limits in which the user is to provide investments in different one of the selected asset classes for the participant, and
determining when the user is to be notified that the investments for the user in the individual ones of the different asset classes are outside of the investment limits established by the user in the individual ones of the asset classes.

7. A method as set forth in claim 6 wherein
the user represents himself or herself.

8. A method as set forth in claim 6 wherein
the user represents an individual other than the user.

9. A method as set forth in claim 6 wherein
the user represents a group or class of individuals.

10. A method as set forth in claim 6 wherein
when the investment in an individual one of the asset classes selected by the user is in excess of limits established by the asset class, dealing with the excess in accordance with instructions from the user.

11. A method as set forth in claim 6 wherein
when the investment in an individual one of the asset classes selected by the user is in excess of limits established by the user for the asset class, dealing with the excess in accordance with one of the following relationships: (a) acknowledging the situation but taking no remedial action, (b) changing the diversification limits in the individual one of the asset classes or (c) changing the asset allocation.

12. A method as set forth in claim 6 wherein
the mode of communicating to the user is changed when the investment in an individual one of the asset classes is outside of the limit established by the user for the asset class.

13. A method as set forth in claim 6 wherein
the user represents (a) himself or herself, (b) an individual other than the user or (c) a group or class of individuals and wherein
when the investment in an individual one of the asset classes selected by the user is in excess of the limit established by the user for the asset class, dealing with the excess in accordance with instructions from the user.

14. A method as set forth in claim 10 wherein
when the investment in an individual one of the asset classes selected by the user is in excess of the limit established by the user for the asset class, dealing with the excess in accordance with one of the following relationships: (a) acknowledging the situation but taking no remedial action, (b) changing the diversification limits in the individual one of the asset classes or (c) changing the asset allocation and wherein
the frequency or mode of communicating to the user is changed when the investment in an individual one of the asset classes is in excess of the limit established by the user for the asset class.

15. In a method of controlling the allocation of investment funds for a user, the steps of:
establishing a plurality of asset classes for the user's investment and a limit for the user's investment in each of the asset classes,
periodically determining the user's investment in each of the asset classes, and
providing a notification to the user, upon each periodic determination, whether or not the user's investment in each asset class exceeds the limit established by the user for the asset class.

16. In a method as set forth in claim 15, the step of:
determining from the user, upon each notification to the user, whether the user wishes to change any of the asset classes or the investment limit in any of the asset classes.

17. In a method as set forth in claim 16, the step of:
providing the notification to the user in a notification mode selected by the user.

18. In a method as set forth in claim 16, the step of:
changing the periodicity of the notification when the notification indicates that the investment of the user in at least an individual one of the asset classes exceeds the specified investment limit for the assets in the asset class.

19. In a method as set forth in claim 16, the step of:
changing the asset classes and the particular limits in each of the asset classes when the user provides a notification to this effect.

20. In a method as set forth in claim 16, the step of:
receiving from the user, upon a notification to the user of an excess above a specified limit in an asset class, one of the following: (a) an acknowledgement of the notification without any change in any of the asset classes, (b) a change in the limits in at least one of the asset classes and (c) a change in the allocation of the investments among the asset classes.

21. In a method of controlling the allocation of investment funds of a user, the steps of:
designating an individual one of a plurality of asset classification systems,
selecting, in the designated one of the asset classification systems, asset classes in which investments are to be provided, and
periodically indicating to the user the investments in each of the selected asset classes and the values of these investments.

22. In a method as set forth in claim 21, the step of:
notifying the user of the investments for the user in each asset class in a notification mode selected by the user.

23. In a method as set forth in claim 21 where the notification mode includes regular mail, facsimile, e-mail and system alert messages.

24. In a method as set forth in claim 21, the step of:
providing an opportunity to the user to change the asset classes in which investments are made for the user.
